(19) United States
(12) Patent Application Publication
(10) Pub. No.: US 2011/0040600 A1
(43) Pub. Date: Feb. 17, 2011

(54) E-DISCOVERY DECISION SUPPORT

(76) Inventors: Deidre PAKNAD, Palo Alto, CA (US); Pierre Raynaud Richard, Redwood City, CA (US); Irina Simpson, Sunnyvale, CA (US)

Correspondence Address: GLENN PATENT GROUP, 3475 EDISON WAY, SUITE L, MENLO PARK, CA, 94025, US

(21) Appl. No.: 12/542,531

(22) Filed: Aug. 17, 2009

(51) Int. Cl. G06F 17/30; G06Q 10/00; G06Q 50/00

(52) U.S. Cl. 705/9; 705/7; 707/E17.032; 707/E17.108

(57) ABSTRACT

Information is gathered from virtual interview responses, an enterprise map, and data repositories. A legal communications and collections component administers virtual interviews. The legal group annotates the virtual interview responses to add data obtained through follow-up interviews, etc. A search engine searches for a list of data sources for each custodian. Preservation and collection instructions are generated either manually or automatically. Custodians can be selectively added to the instructions based on the virtual interview responses. The instructions for the custodians are grouped according to the data source. The preservation and collection instructions are transmitted to the IT staff or data sources for implementation.

### BACKGROUND OF THE INVENTION

1. Technical Field

The invention relates to e-discovery. More particularly, the invention relates to software technology for gathering e-discovery information and structuring preservation and collection instructions.

2. Description of the Related Art

Electronic discovery, also referred to as e-discovery or EDiscovery, concerns electronic formats that are discovered as part of civil litigations, government investigations, or criminal proceedings. In this context, the electronic form is anything that is stored on a computer-readable medium. Electronic information is different from paper information because of its intangible form, volume, transience, and persistence. In addition, electronic information is usually accompanied by metadata, which is rarely present in paper information. Electronic discovery poses new challenges and opportunities for attorneys, their clients, technical advisors, and the courts, as electronic information is collected, reviewed, and produced.

Examples of the types of data included in e-discovery include e-mail, instant messaging chats, Microsoft Office files, accounting databases, CAD/CAM files, Web sites, and any other electronically-stored information which could be relevant evidence in a lawsuit. Also included in e-discovery is raw data which forensic investigators can review for hidden evidence. The original file format is known as the native format. Litigators may review material from e-discovery in any one or more of several formats, for example, printed paper, native file, or as TIFF images.

The process of collecting data from data sources is referred to as a collection request. The process of instructing a data source to preserve information is referred to as a hold request. Automatic propagation of collection requests and hold requests from electronic discovery management systems to data sources is an emerging area. Current approaches to e-discovery are expensive due to the repeated manual steps and processes. Also, there is no well established and agreed upon understanding of how automatic propagation of collection and hold requests can be accomplished in a way that is both robust and defensible. For example, evidence may be spoiled due to misuse or over handling. Further, it is often necessary to repeat discovery due to the poor integrity afforded by current approaches.

The first step in preserving data and evidence in anticipation of litigation or during litigation is to identify the custodians and data sources. Custodians are defined as anyone that has control over information that is potentially relevant to the legal matter. The data sources comprise anything that stores data, e.g. computer, cell phone, server, etc. Identifying custodians and data sources is a difficult task for large, global enterprises because of the distributed and often-changing business structure as well as the expanding information landscape.

The staff responsible for conducting preservation and collections, typically the information technology (IT) staff, receives the information about custodians and data sources. The staff may also receive additional instructions for enacting holds and collections automatically. The efficiency and defensibility of the process is improved if the legal group that is managing the e-discovery efforts provides the staff with appropriate preservation and collection instructions.

### SUMMARY OF THE INVENTION

In one embodiment of the invention, a method and apparatus gather information from virtual interview responses, an enterprise map, and data repositories. A legal communications and collections (LCC) component administers the virtual interviews and searches external resources for additional data. The legal group annotates the virtual interview responses to add data obtained through follow-up interviews, etc.

Preservation and collection instructions are generated either manually or automatically. The instructions for the custodians are grouped according to the data source. The instructions include a customizable display of the virtual interview responses. The preservation and collection instructions are transmitted to the IT staff for implementation.

If the LCC component receives virtual interview responses after the preservation and collection instructions are generated, custodians with relevant information are flagged and the legal group decides whether to update the instructions.

### BRIEF DESCRIPTION OF THE DRAWINGS

FIG. 1 is a block diagram that illustrates a network in which systems and methods for preserving data are employed according to one embodiment of the invention;

FIG. 2 is a block diagram that illustrates a client according to one embodiment of the invention;

FIG. 3 is a block diagram of components in a system for preserving data according to one embodiment of the invention;

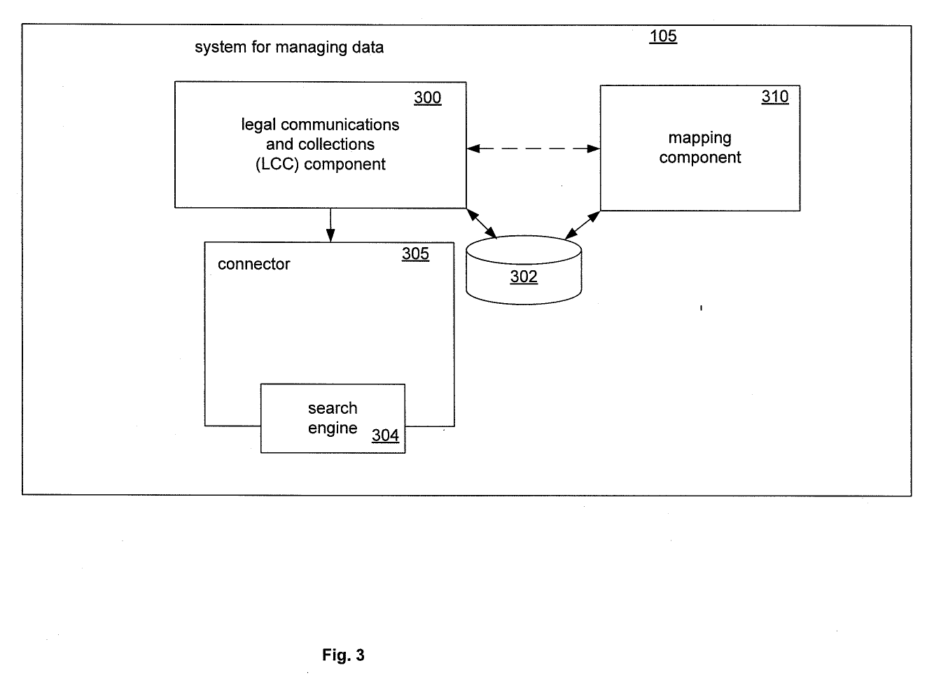

FIG. 4 is an example of a virtual interview questionnaire according to one embodiment of the invention;

FIG. 5 is a block diagram that illustrates the transmission of information between different custodians and data sources;

FIG. 6 is a flow diagram that illustrates the steps for preserving data according to one embodiment of the invention;

FIG. 7 is a flow diagram that illustrates a manual instruction creation workflow according to one embodiment of the invention;

FIG. 8 is a block diagram that illustrates a user interface for specifying collection and preservation instructions according to one embodiment of the invention;

FIG. 9 is a flow diagram that illustrates an automatic instruction creation workflow according to one embodiment of the invention; and

FIG. 10 is a block diagram that illustrates the sources of data used to generate the collection and preservation instructions according to one embodiment of the invention.

### DETAILED DESCRIPTION OF THE INVENTION

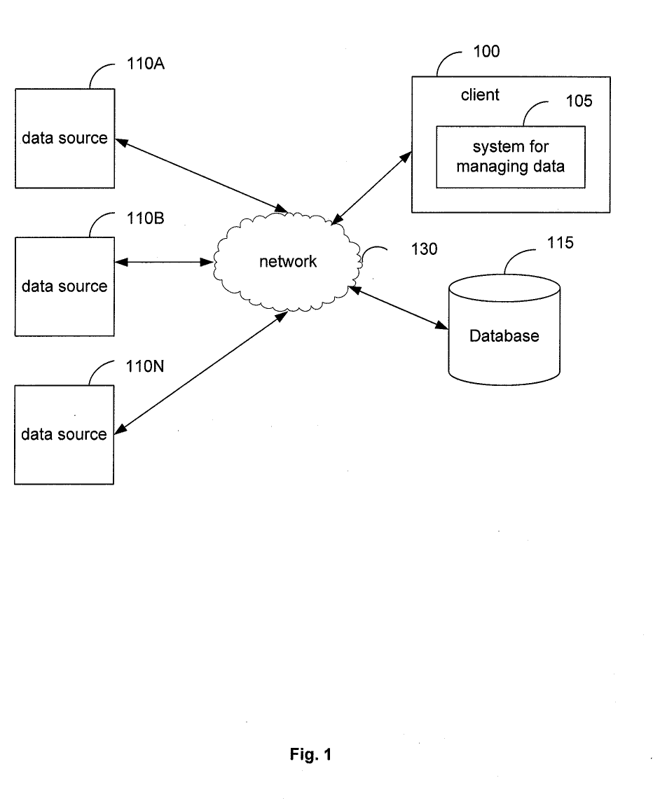

FIG. 1 is a block diagram that illustrates a network in which systems and methods for preserving data are employed according to one embodiment of the invention. In one embodiment, the system for managing data 105 is stored on a client 100. A client 100 comprises a computing platform configured to act as a client device, e.g. a personal computer, a personal digital assistant (PDA), a laptop, a server, etc.

The system for managing data 105 communicates over a network 130 to locate various data sources 110A, 110B, 110N, etc. In one embodiment, the data sources are servers. The network 130 can be a wired network, such as a local area network (LAN), a wide area network (WAN), a home network, etc., or a wireless local area network (WLAN), e.g. Wifi, or wireless wide area network (WWAN), e.g. 2G, 3G, 4G. In one embodiment the system for managing data 105 stores data gathered from the data sources on a remote server with a database 115. In another embodiment, the data is stored directly on the client 100.

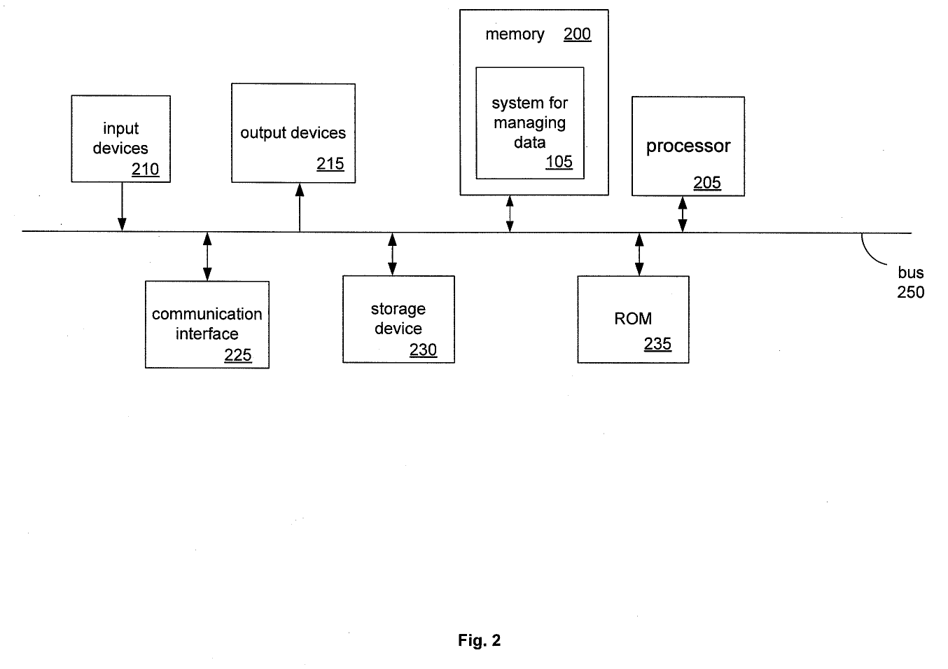

FIG. 2 is a block diagram of a client 100 according to one embodiment of the invention. The client 100 includes a bus 250, a processor 205, a main memory 200, a read only memory (ROM) 235, a storage device 230, one or more input devices 210, one or more output devices 215, and a communication interface 225. The bus 250 includes one or more conductors that permit communication among the components of the client 100.

The processor 205 may include one or more types of conventional processors or microprocessors that interpret and execute instructions. Main memory 200 may include random access memory (RAM) or another type of dynamic storage device that stores information and instructions for execution by the processor 205. ROM 235 may include a conventional ROM device or another type of static storage device that stores static information and instructions for use by the processor 205. The storage device 230 may include a magnetic and/or optical recording medium and its corresponding drive.

Input devices 210 may include one or more conventional mechanisms that permit a user to input information to a client 100, such as a keyboard, a mouse, etc. Output devices 215 may include one or more conventional mechanisms that output information to a user, such as a display, a printer, a speaker, etc. The communication interface 225 may include any transceiver-like mechanism that enables the client 100 to communicate with other devices and/or systems. For example, the communication interface 225 may include mechanisms for communicating with another device or system via a network 130.

The software instructions that define the system for managing data 105 may be read into memory 200 from another computer readable medium, such as a data storage device 230, or from another device via the communication interface 225.

The processor 120 can execute computer-executable instructions stored in the memory 200. The instructions may comprise object code generated from any compiled computer-programming language, including, for example, C, C++, C# or Visual Basic, or source code in any interpreted language such as Java or JavaScript.

System Components

In one embodiment, the system for managing data 105 comprises a legal communications and collections (LCC) component 300, a connector 305, and an enterprise mapping component 310.

To generate meaningful preservation or collection instructions, the legal staff needs a list of custodians, data sources where the information is kept, and additional details about the information and the data source. First, the legal staff generates a list of custodians. Then the data sources associated with the custodians are identified.

Details about the location of potentially relevant information are gathered from an enterprise map, external systems, and interviews. The enterprise map displays the relationships between data sources and custodians. External systems include asset management systems and search engines. The interviews are typically virtual interviews that are generated by the LCC component.

LCC Component

The LCC component 300 allows attorneys and paralegals to inquire or interview employees or contractors as to their information habits and data in their custody. This process is automated through the use of virtual interviews. The LCC component 300 organizes and stores the names of the custodians, data sources, tags, templates, etc. in a database 302.

### Virtual Interview

The virtual interview is a user interface that gathers custodians' knowledge about their data keeping habits by requesting the custodians to identify the types of relevant information, e.g. files, emails, etc., where they keep it, e.g. desktop, a shared server, a content management system, etc., and additional details about the location, e.g. My Documents on the desktop, the directory on the shared server, etc. The virtual interview accepts completed interviews as well as partially completed interviews. For example, in one embodiment, a custodian can skip answers or submit the interview before reviewing all the questions.

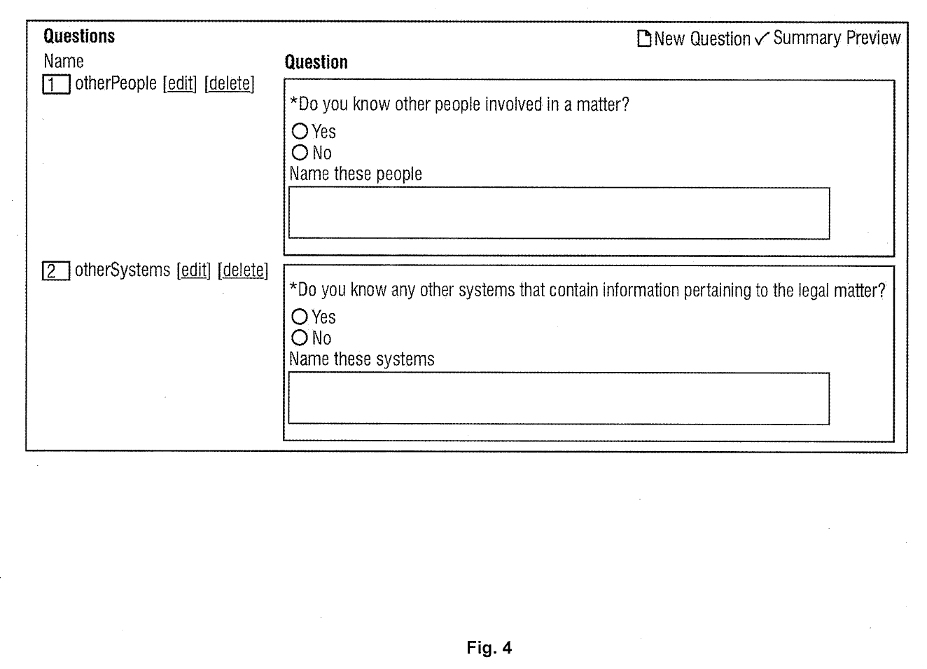

FIG. 4 is an example of a virtual interview questionnaire according to one embodiment of the invention. In this example, the other people involved in the matter, i.e. custodians and the other systems, i.e. data sources may be suggested by the virtual interview. This user interface is easily modified to include a pull-down list of custodians and data sources.

The virtual interview allows the user to specify multiple locations for a file. For example, a custodian selects a file share source. In one embodiment, the virtual interview prompts the custodian to enter a home directory in a specially designated field and additional locations in other fields, such as a work location, etc. In another embodiment, the custodian provides a more generic description of the data sources. In another, legal interviews the custodian and fills out the virtual interview on her behalf.

Members of the legal group review the virtual interviews and provide annotations to the results. The virtual interview responses and annotations are included in the preservation and collection instructions. As a result, the process of generating preservation and collection instructions is further automated because the annotations are automatically integrated instead of being entered through a tedious data entry process.

The order of the responses and the annotations is configurable. The responses are displayed with associated annotations or the annotations supersede the responses and serve as a corrected version of the custodian-specific instructions for preservation or collection.

Connector

The connector 305 transfers data between two or more applications and obtains data pursuant to a request from the LCC component 300. The connector 305 automatically gathers information from other systems, preserves, or instructs a data source to preserve, data and collects data stored in the data sources in response to instructions received from the LCC component 300.

The connector 305 can also be used to gather information from systems regarding associations between custodians and data sources. For example, the search engine 304 automatically gathers data from an asset management system that contains data on assets issued to custodians, etc. The search engine 304 communicates the data to the LCC component 300, which may use the data to automatically generate preservation or collection instructions.

The connector 305 uses web services, structured HTTP requests, local or remote procedure calls, etc. to preserve and collect the data. In one embodiment, the connector 305 interfaces with data sources 110A, 110B, and 110N using an application programming interface (API). In another embodiment, the connector 305 is part of the data sources 110A, 110B, and 110N.

Communication between the LLC component 300 and the connector 305 is unidirectional or bidirectional. Unidirectional communication occurs when the LLC component 300 instructs the connector 305 to perform various services. Bidirectional communication occurs when the connector 305 instructs the LLC component 300 to perform services as well.

The connector 305 preserves or instructs a data source to preserve data by protecting the data against destruction or alteration. The connector 305 can send hold notices to IT staff, who manually implement holds on the data. In one embodiment, the connector 305 directly implements holds by instructing the server that manages the data to disable routine deletion of the data, any janitor programs that may modify the data, etc. This may occur, for example, by tagging the data item or moving it to a special staging area within the server.

In one embodiment, the connector 305 collects the requested data from the data sources 110A, 110B, and 110N and stores it in another location, such as a database 120. In another embodiment, the connector 305 stores the data in a database 302 that is on the client. This scenario is less likely, however, because the size of the collection can easily exceed a terabyte of space.

A more detailed explanation of the communications between the LCC component (referred to as an EMA) and the connector can be found in U.S. application Ser. No. 11/963,383, which is herein incorporated by reference. Once the connector 305 collects all the data, the legal group can review and annotate the data.

### Search Engine

In one embodiment, the connector 305 includes or interfaces with a search engine 304 that searches for data sources that contain data associated with a particular custodian. For example, the search engine can gather information stored in various data sources and provide a list of custodians who are file owners in each of the data sources.

In another embodiment, the search engine 304 is part of the LCC component 300. In this embodiment, the search engine 304 either communicates directly with the systems or via the LCC component 300.

Mapping

The enterprise mapping component 310 gathers information for mapping the paths between custodians and data sources and stores the enterprise map in a database 302. The visual representation of the relationships between custodians and data sources is very helpful for the legal staff.

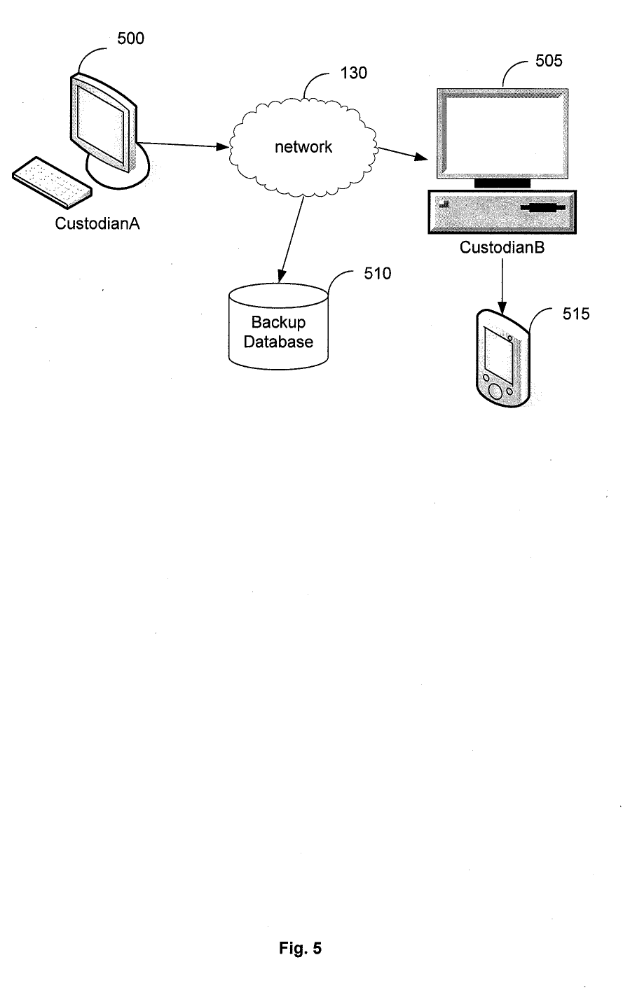

FIG. 5 is a block diagram that illustrates one simple example of an enterprise map according to one embodiment of the invention. In this example, there are two custodians and four data sources. The map illustrates that the custodians store information on their work computers 500 and 505, a backup database 510, and Custodian B also uses a portable device 515.

The data source and custodian mapping information is gathered automatically by the LCC component 300. The information is mapped either from the data source to the custodian or from the custodian to the data source. The LCC component 300 communicates directly with the enterprise mapping component 310 or indirectly through the connector 305 to gather the relevant data. In one embodiment, the information obtained by the LCC component 300 from the enterprise mapping component 310 is unstructured and requires user review. In another embodiment, the information is structured and parameterized.

Process

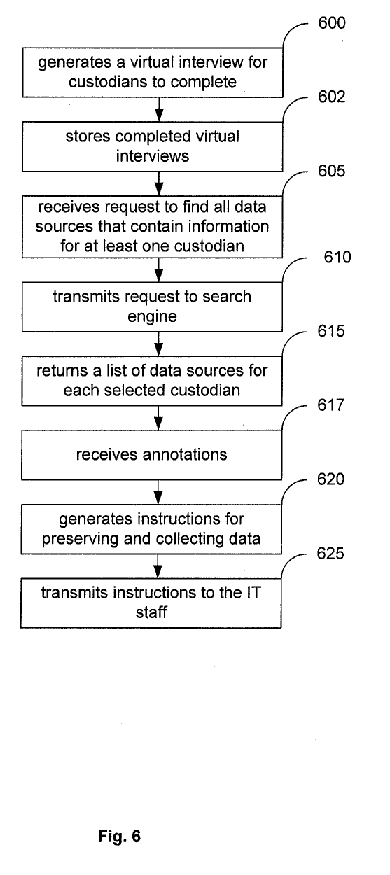

FIG. 6 is a process diagram that illustrates steps for automatic gathering of data source and custodian mapping information. The LCC component 300 generates 600 a virtual interview for custodians to complete. The LCC component 300 receives and stores 602 data obtained from the virtual interviews. The LCC component 300 receives 605 a request to find all data sources that contain information for at least one custodian. Additional search parameters, such as time, keywords, subject matter, etc. can be provided.

The LCC component 300 transmits 610 the request to the search engine 302. The search engine 302 returns 615 a list of data sources for each selected custodian. Additional details can also be provided, such as a list of directories that contain potentially relevant information. The LCC component 300 receives 617 annotations from a member of the legal group.

The LCC component 300 generates 620 instructions for preserving and collecting data. The instructions are manually or automatically generated based on the data gathered through virtual interviews, the results gathered by the search engine, and data gleaned from the enterprise map. The instructions are manually or automatically tailored to include only the custodians that provided a particular answer to at least one interview question, custodians that received at least one particular asset, or custodians that have data stored in at least one data source as reflected in the enterprise map.

An example of an instruction is to collect all information with a particular keyword for a particular date range that is displayed with annotations that were provided by the user.

The collection and preservation instructions are transmitted 625 directly to the IT staff. This further automates the process because the IT staff does not re-type any of the data or keep track of their own list of custodians or follow up with the custodians to locate the data sources. As a result, the legal group provides clear, precise custodian-specific instructions to the IT staff. There is no duplicate record keeping of tasks for the IT staff. There is no confusion regarding when to collect data from which custodian. A single set of facts is shared by everyone involved in the e-discovery process.

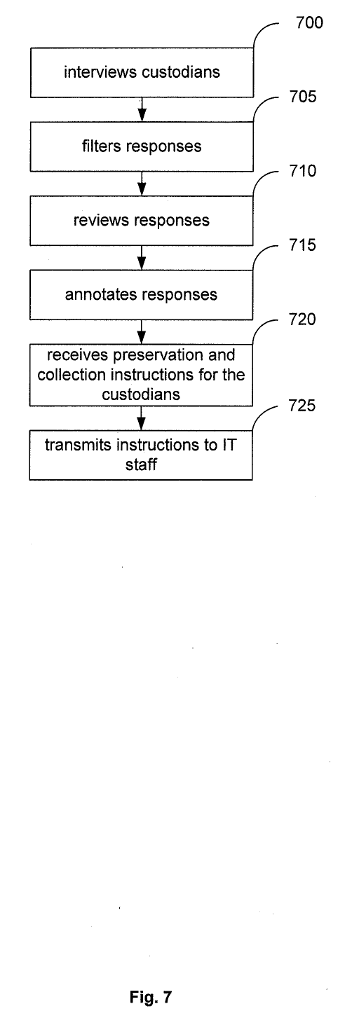

FIG. 7 is a flow diagram that illustrates a manual instruction creation workflow according to one embodiment of the invention. The LCC component 300 interviews 700 custodians and receives responses. The LCC component filters 705 the responses according to various criteria, e.g. questions, batch of custodians, answers, etc. specified by a member of the legal group. The legal group reviews 710 the responses. The legal group annotates 715 the responses.

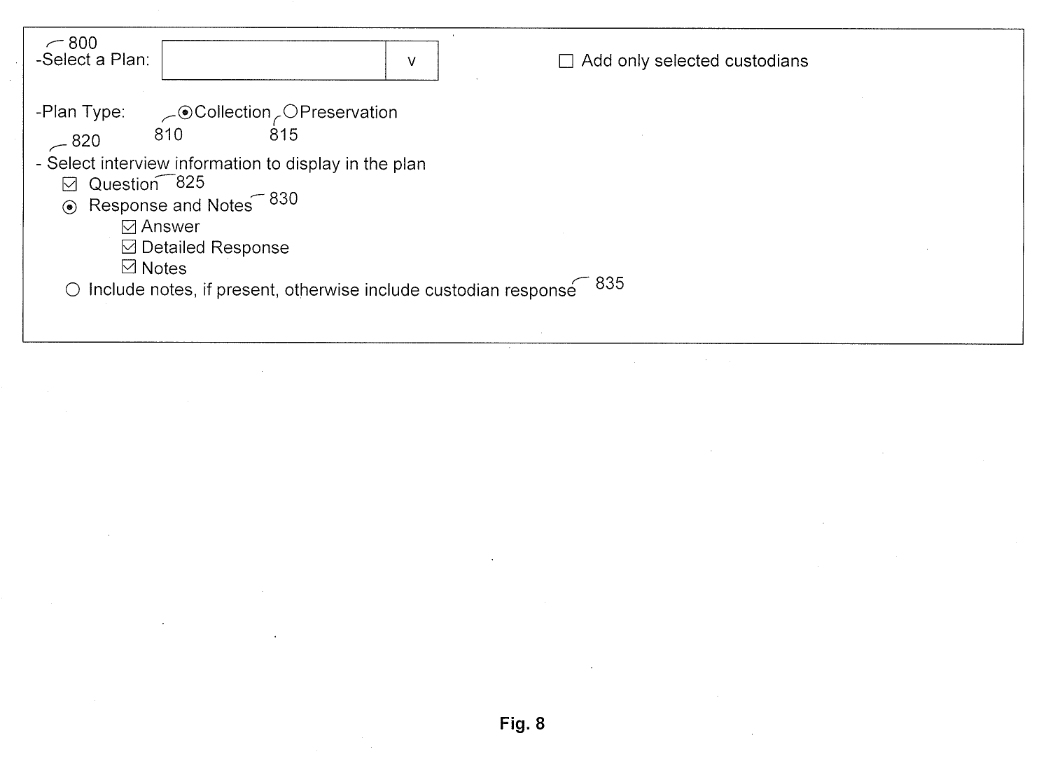

FIG. 8 is an example of a user interface displayed for the legal group that allows the user to specify which interview results and in what form the results are displayed as part of the preservation and collection instructions. Specifically, the user can select a plan 800, whether to add only selected custodians 805, and whether the plan type is specified as a collection 810 or preservation 815. The user interface also allows the user to specify the interview information that is displayed with the plan 820. Specifically, the LCC component 300 displays the question 825, and either the response and notes 830 or the notes if present, otherwise include custodian responses 835, i.e. the legal group annotation supersedes the responses. Within the option of displaying the response and notes 830, the LCC component 300 displays any of the answer, the detailed response, and notes.

In one embodiment, the list of custodians added to preservation and collection instructions is filtered according to the answers. In this configuration, adding a custodian to the collection request is trivial. For example, only custodians that responded positively regarding information on a particular file share are included in a collection instruction for that file share.

The LCC component 300 generates 720 preservation and collection instructions for the custodians and/or data sources. The LCC component 300 transmits 725 the instructions to the IT staff or a data source for automatic execution.

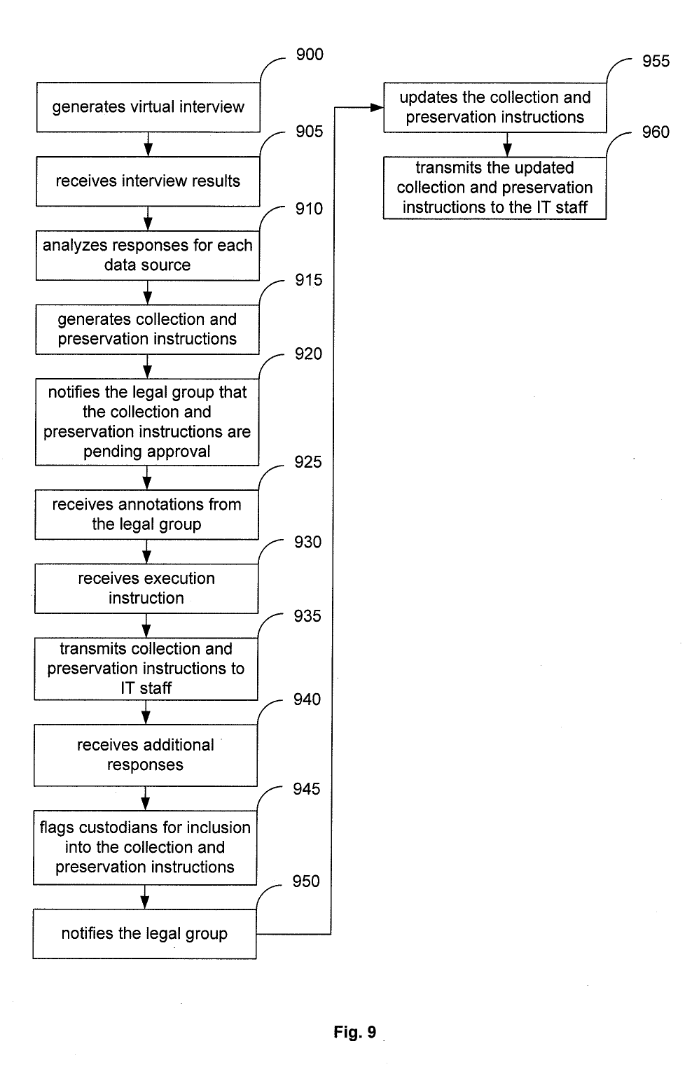

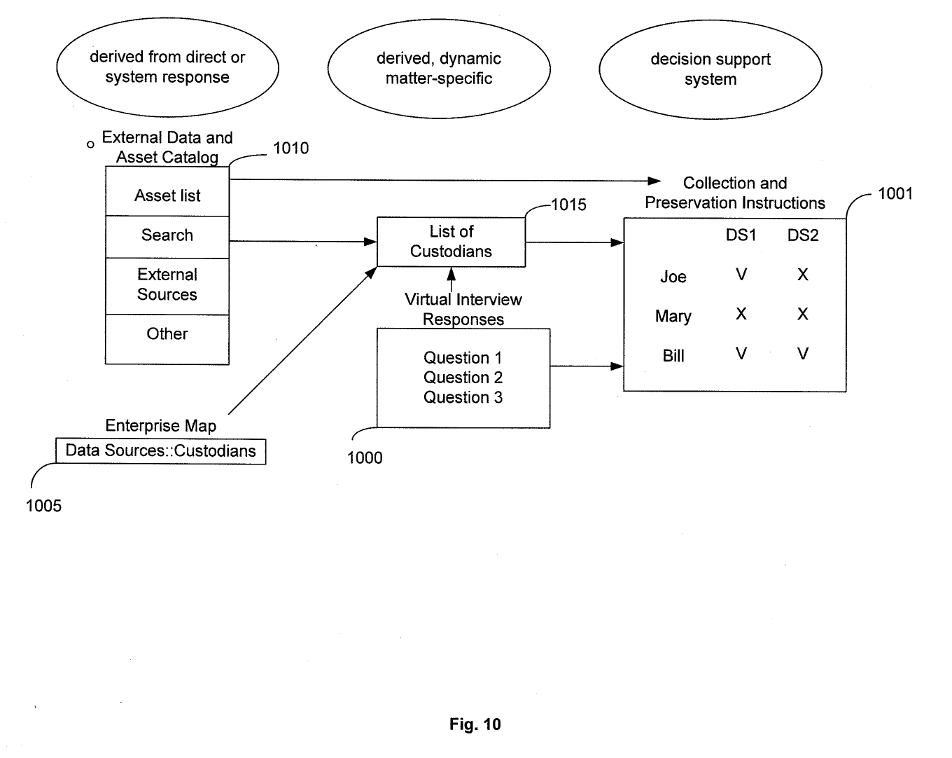

FIG. 9 is a flow diagram that illustrates an automatic instruction creation workflow according to one embodiment of the invention. FIG. 10 is a block diagram that illustrates the sources of data used to generate the collection and preservation instructions according to one embodiment of the invention. The instructions are organized according to rules provided by the legal group and configuration parameters or templates that specify what type of an instruction is pre-planned.

The LCC component 300 generates 900 virtual interviews and receives 905 virtual interview responses 1000. The LCC component 300 analyzes 910 the responses for each data source. The LCC component generates 915 the collection and preservation instructions 1001 based on the virtual interview responses 1000, the enterprise map 1005, and an external data and asset catalog 1010. Custodians are added to the list of custodians 1015 when, based on a pre-configured set or template, the custodian provides an answer that qualifies. For example, if the custodian states that his desktop computer contains information relating to the litigation, the custodian is included in the list of custodians 1015. The LCC component 300 notifies 920 the legal group that the collection and preservation instructions 1001 are pending approval. A member of the legal group reviews the collection and preservation instructions 1001. The LCC component 300 is configured to receive 925 annotations from the legal group including instructions to add or remove a custodian.

The preservation and collection instructions 1001 remain in a draft state until the LCC component 300 receives 930 an execution instruction from the legal group. The preservation and collection instructions 1001 and custodians are grouped for each data source. The LCC component 300 transmits 935 the collection and preservation instructions 1001 to the IT staff.

If the LCC component 300 receives 940 additional responses, the LCC component 300 flags 945 custodians for inclusion into the collection and preservation instructions 1001. The LCC component 300 notifies 950 the legal group about the custodians that could be added to the instructions. The legal group reviews the changes and approves or rejects the changes. The LCC component 300 updates 955 the collection and preservation instructions 1001 accordingly and transmits 960 the updated collection and preservation instructions to the IT staff.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method for managing data for e-discovery on a computer comprising a processor and a memory, the processor configured to implement steps stored in the memory, comprising the steps of:
generating, with the computer, a virtual interview to capture the custodians' knowledge;
receiving, with the computer, a plurality of virtual interview responses;
determining, with the computer, a list of custodians based on the virtual interview responses;
searching, with the computer, for a list of data sources for each custodian;
generating, with the computer, an enterprise map; and
generating, with the computer, a plurality of instructions for collecting and preserving data based on any of the following: the virtual interview responses, the list of custodians, the list of data sources for each custodian, and the enterprise map.

2. The method of claim 1, further comprising the step of:
transmitting, with the computer, the set of instructions for collecting and preserving data to any of an information technology (IT) staff member and a data source.

3. The method of claim 1, further comprising the steps of:
notifying, with the computer, a legal group that the instructions for collecting and preserving data are pending approval; and
receiving, with the computer, execution instructions for collecting and preserving data from the legal group.

4. The method of claim 3, further comprising the step of:
receiving, with the computer, an annotation of any of the virtual interview responses and the instructions for collecting and preserving data from a legal group.

5. The method of claim 1, further comprising the step of:
receiving, with the computer, additional instructions for collecting and preserving data.

6. The method of claim 1, further comprising the step of:
filtering, with the computer, the virtual interview responses for display.

7. The method of claim 1, further comprising the steps of:
receiving, with the computer, additional virtual interview responses;
flagging, with the computer, custodians for inclusion into the instructions for collecting and preserving data;
notifying, with the computer, a legal group;
receiving, with the computer, approval from the legal group to update the instructions for collecting and preserving data; and
updating, with the computer, the instructions for collecting and preserving data.

8. The method of claim 1, further comprising the step of:
selectively adding a custodian to the instructions for collecting and preserving data based on any of the virtual interview responses and any search results.

9. The method of claim 1, further comprising the step of:
searching, with the computer an asset management system to obtain data on assets issued to custodians.

10. The method of claim 1, wherein the step of generating the instructions for collecting and preserving data occurs automatically or in response to input from a user.

11. A system for managing data for e-discovery, comprising:
a memory;
a processor, the processor configured to implement instructions stored in the memory, the memory storing executable instructions;
a legal communications and collections (LCC) component for generating a virtual interview to capture the custodians' knowledge and for receiving a plurality of virtual interview responses;
a search engine for searching for a list of data sources for each custodian;
an enterprise map component for generating an enterprise map;
wherein the LCC component generates a plurality of instructions for collecting and preserving data based on any of the following: the virtual interview responses, the list of custodians, the list of data sources for each custodian, and the enterprise map.

12. The system of claim 11, wherein the LCC component transmits the set of instructions for collecting and preserving data to any of an information technology (IT) staff member and a data source.

13. The system of claim 11, wherein the LCC component notifies the legal group that the instructions for collecting and preserving data are pending approval and the LCC component receives execution instructions for collecting and preserving data from the legal group.

14. The system of claim 11, wherein the LCC component selectively adds a custodian to the instructions for collecting and preserving data based on any of the virtual interview responses and any search results.

15. A computer program product for tracking managing data for e-discovery comprising a computer-readable storage medium storing program code for executing the following steps:
generating a virtual interview to capture the custodian's knowledge;
receiving a plurality of virtual interview responses;
determining a list of custodians based on the virtual interview responses;
searching for a list of data sources for each custodian;
generating an enterprise map; and
generating a plurality of instructions for collecting and preserving data based on any of the following: the virtual interview responses, the list of custodians, the list of data sources for each custodian, and the enterprise map.

16. The computer program product of claim 15, further comprising the step of:
transmitting the set of instructions for collecting and preserving data to any of an information technology (IT) staff member and a data source.

17. The computer program product of claim 15, further comprising the steps of:
notifying a legal group that the instructions for collecting and preserving data are pending approval; and
receiving execution instructions for collecting and preserving data from the legal group.

18. The computer program product of claim 17, further comprising the step of:
receiving an annotation of any of the virtual interview responses and the instructions for collecting and preserving data from a legal group.

19. The computer program product of claim 15, further comprising the step of:
receiving additional instructions for collecting and preserving data.

20. The computer program product of claim 15, further comprising the step of:
selectively adding a custodian to the instructions for collecting and preserving data based on any of the virtual interview responses and any search results.
